(19) United States
(12) Patent Application Publication
(10) Pub. No.: US 2007/0075827 A1
(43) Pub. Date: Apr. 5, 2007

(54) Service provision method

(75) Inventors: Meiji Itoh, Kanagawa-ken (JP); Kazuhiro Mino, Kanagawa-ken (JP); Akira Yoda, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/540,680

(22) Filed: Oct. 2, 2006

(30) Foreign Application Priority Data
Sep. 30, 2005 (JP) 286776/2005

(51) Int. Cl. G06K 9/00

(52) U.S. Cl. 340/5.53; 382/115; 340/5.83; 382/118

(57) ABSTRACT

In a service provision method wherein a person is authenticated by a face image recording medium and granted a predetermined request right for provision of a predetermined service by presentation of the request right, a service provider issues a reservation by combining recognition data of the service and validation data specific thereto when the person having been authenticated requests the reservation based on the request right. When provision of the reserved service is requested, the request is received by presentation of a combination of recognition data and specific validation data. The service is provided in the case where the combination agrees with the combination used at the time of issuing the reservation. Therefore, the service can be provided to another person other than the person having the request right.

### BACKGROUND OF THE INVENTION

1. Field of the Invention

The present invention relates to a service provision method. More specifically, the present invention relates to a service provision method for carrying out authentication of a person by face image data.

2. Description of the Related Art

Identification photographs have conventionally been photographed in stand-alone self-photography booths, and users thereof easily obtain photographs of themselves for various kinds of applications. The photographs of this type are printed on printing paper and pasted on application forms or turned in with the forms.

Meanwhile, various types of transactions are carried out on the Internet, and applications can also be filed via the Internet. Applications for official procedures and for memberships of organizations can also be made on the Internet. Since face photographs of applicants often need to be turned in for these types of applications, it is thought to be an effective method to send data obtained by reading identification photographs with scanners or data obtained by digital cameras together with application data.

However, photograph data generated by individuals can be manipulated by use of various kinds of photograph processing software, and the photograph data are therefore not verified to be authentic photograph data not having had manipulation thereon. Therefore, it is convenient to have face photograph data verified in terms of the genuineness thereof.

As a method for preventing falsification of identification photographs that can meet such a demand, a method proposed by the present assignee is known (see Japanese Unexamined Patent Publication No. 2003-244347). In the method described in Japanese Unexamined Patent Publication No. 2003-244347, information including photography permission information and photography history information is added to image data obtained through photography of a user by a photography organization with photography means permitted by a photography permission organization, and stored in a database. In addition, the image data added with the accompanying information are sent to a personal computer of the user via a network, and sent to an image using organization from the personal computer. The image using organization having received the data carries out image authentication regarding whether the image data have actually been obtained by photography of the user without falsification thereof. More specifically, image judgment means in the image using organization extracts the information added to the image data, and accesses the photography organization via the network for comparison with the information stored in the database of the photography organization. In this manner, the image data are authenticated.

The photography permission organization also has photography permission issuing means and a database. The photography permission issuing means permits photography of an identification photograph by the photography means in the case where the photography organization requests the permission via the network by identifying the photography means. At this time, photography permission information including photography conditions, image generation conditions such as a range of manipulation, and a permission period is added to the issued permission. The photography permission information is also stored in the database. The photography permission organization is a third-party organization for authenticating identification photographs and separated from the photography organization, the personal computer of the user, and the image using organization. The photography permission organization permits the photography means to photograph an identification photograph in the case where the photography organization requests the permission via the network by identifying the photography means.

Therefore, in this method, the photography organization and the photography permission organization are necessary besides the user, and authentication needs to be carried out through inquiry to the photography organization.

However, in reality, means for generating an identification photograph of a user, that is, a face image recording medium for electronic application, with the same ease as in the case of a conventional stand-alone self-photography booth is desired. In addition, in order to prevent use by another person in the case where the face image recording medium for electronic application is lost, invalidation of the medium is desired. In this case, it is desired for the invalidation to be carried out easily by the user but to be impossible by a person other than the user. Furthermore, reissuing an effective face image recording medium for electronic application is desired after or upon the invalidation.

Consequently, such demands may be satisfied by a face image recording medium storing face image data verified in terms of authenticity and obtained easily by a user without a photography organization or a photography permission organization.

Such a face image recording medium generated in the above manner can be used not only for electronic applications, but also for identification of a person as has been carried out by use of a conventional seal registration certificate or a health insurance certificate. More specifically, if a person brings such a face image recording medium to an official organization or a store and face image data therein are compared with image data obtained by photography of the face of the person for judging agreement between the faces represented by the data, the person can be authenticated properly.

In a method of authentication using such a face image recording medium, a person who found the recording medium cannot use the medium illegally to pretend to be the holder. In addition, personal information can be prevented from being leaked since no personal information needs to be recorded in the recording medium.

The authentication method described above can be applied to a service provision method wherein a predetermined request right is granted to a person having been authenticated and a predetermined service is provided in response to presentation of the request right. As an example of such a case is listed a case where a right to reserve play at a golf course is issued as the request right after authentication of a person and the course is provided for use as a service based on the right. As another example can be listed the case where a right to reserve tickets at a ticket agency is issued as the request right after authentication of a person and a ticket is sold as a service based on the right.

Meanwhile, the case may occur where a person to receive such a service cannot play golf or use a ticket (for going to a concert or the like) due to an unexpected situation. Furthermore, the person may naturally wish to invite his/her acquaintance to a golf club he/she has a membership with, to allow the acquaintance to play with the person.

In order to deal with such a situation or demand, it is convenient if another person is allowed to use the request right instead of the person granted the right. However, no service provision method has been proposed that allows such use by authentication using a face image recording medium.

### SUMMARY OF THE INVENTION

The present invention has been conceived based on consideration of the above circumstances. An object of the present invention is therefore to enable provision of a predetermined service to a person other than a person to whom a predetermined request right is granted, in a service provision method wherein the person is authenticated by use of a face image recording medium and granted the right to be provided with the service in response to presentation of the right.

As has been described above, a service provision method of the present invention is a service provision method for providing a predetermined service in response to presentation of a predetermined request right granted to a person authenticated by a face image recording medium readable by a computer and storing face image data of the person, authenticity information indicating that the face image data represent a genuine image of the person, and information representing an effective period in a state enabling no falsification thereof, and the method comprises the steps of:

issuing a reservation of the service with a combination of recognition data of the service and validation data specific thereto in the case where the person having been authenticated requests the reservation of the service based on the request right;

receiving a request for provision of the service having been reserved, by causing a combination of recognition data of the service and validation data specific thereto to be presented; and

providing the requested service in the case where the presented combination agrees with the combination used at the time of issuing the reservation.

In the service provision method of the present invention, in the case where a person requesting provision of the service is not the same as the person having been authenticated, it is preferable for the service to be provided only for a predetermined number of times or less. Alternatively, in this case, the service may be provided only for preset types of reservations.

The authenticity information indicating the genuine image of the person refers to information indicating that photography has been carried out by a photography apparatus that does not enable manipulation thereon. For example, the authenticity information may be a model number specific to the photography apparatus, or an electronic watermark that can be embedded only by the photography apparatus. Alternatively, the photography apparatus may monitor a manner of the photography for confirmation of the photography being carried out in a normal state. In this case, the authenticity information is recorded for representing genuineness of the image without manipulation, on condition that the confirmation has been made. In the case where biometrics data such as a fingerprint are also obtained at the time of photography of the face, monitoring and confirmation may be made as to whether the face and a finger belong to the same person.

The effective period refers to a period in which the recording medium can be used effectively. For example, the effective period may be a predetermined period such as 6 months starting from the time of photography that is generally required for a general identification photograph, since human faces change with time.

Recording the face image data and the information in the computer-readable recording medium in the state enabling no falsification thereof refers to recording in a read-only state. More specifically, the recording can be realized by using a recording medium that allows only writing therein (ROM). Alternatively, the recording can be realized by recording an electronic watermark together with the image. In the case of electronic watermark, the electronic watermark can also be used as the authenticity information representing that the face image data have not been manipulated or falsified, which is convenient.

The face image recording medium may store biometrics data such as a fingerprint, an iris pattern, or a vein pattern of a finger or palm/back of a hand of the person in addition to the face image data, in the state enabling no falsification thereof.

On a surface of the face image recording medium, it is preferable for the face image represented by the face image data to be printed in a visible state so that the person or a person handling the recording medium can easily confirm the face image.

Furthermore, it is also preferable for the face image data to be stored in the face image recording medium after being converted into hash values.

According to the service provision method of the present invention, when the reservation for the service is requested based on the request right of the person having been authenticated, the reservation is issued by combining the recognition data of the service with the specific validation data. The request for provision of the reserved service is received upon presentation of the combination of the recognition data of the service with the specific validation data. The requested service is then provided only in the case where the presented combination is the same as the combination used at the time of issuing the reservation. Therefore, the person who made the reservation can naturally receive the service by properly presenting the combination of the recognition data of the service and the specific validation data.

Upon transfer of the reservation of the service from the person who made the reservation to another person, the person to whom the reservation is transferred can present the combination properly in the case where the person who initially made the reservation notifies the combination properly. Therefore, the person to whom the reservation is transferred can receive the service. In other words, a provider of the service can recognize that the person who presents the combination is one to whom the reservation was transferred by the person who made the reservation, by the correct presentation of the combination.

As has been described above, it is impossible for another person who found the face image recording medium to illegally use the recording medium by pretending to be the person. In addition, since no personal information needs to be recorded in the face image recording medium, personal information can be prevented from being leaked.

In the service provision method of the present invention, in the case where the requested service is provided only within the predetermined number of times if the person requesting provision of the service is not the same as the authenticated person, the request right can be prevented from being abused for a person other than the holder.

The request right using the face image recording medium described above can be managed collectively by an organization such as a credit card firm, for various kinds of reservations such as for a ticket, a restaurant, or a golf course. However, each member store may have a different wish, such as the case where a restaurant having a contract for the collective management allows use by another person while another restaurant or a ticket agency does not allow use by another person. Therefore, in the case where the person requesting provision of the service is different from the authenticated person, the state where each member store has a different wish can be dealt with if the requested service is provided only for the preset type of reservation (such as reservation by specifying the name of a store).

Since it is easy for letting a confirmation apparatus confirm expiration of the effective period of the face image recording medium used in the service provision method of the present invention, the recording medium whose effective period has expired may automatically become unusable.

In the case where the biometrics data other than the face are also recorded in the face image recording medium of the present invention, the person can be authenticated by the biometrics data even in the case where the face of the person has changed. Therefore, the biometrics data can be used for authentication of the person, depending on uses. In addition, in the case where a face image recording medium is newly generated (that is, the case where the recording medium generated in the past is updated) so that the image data of the face having changed are stored therein, the recording medium can be generated through authentication of the person by use of the biometrics data. For generation of the face image recording medium (or update of the old face image recording medium), the biometrics data that do not change are recorded in the new recording medium as they are while the face image data are updated.

### BRIEF DESCRIPTION OF THE DRAWINGS

FIG. 1 is a side view showing an example of a face image recording media generation apparatus;

FIG. 2 shows the configuration of a control apparatus of the face image recording media generation apparatus shown in FIG. 1;

FIG. 3 shows the configuration of an example of a system that carries out a service provision method of the present invention;

FIG. 4 shows an example of an operation panel of an apparatus that generates, invalidates, and reissues a face image recording medium; and

FIG. 5 shows procedures in the service provision method in an embodiment of the present invention.

### DESCRIPTION OF THE PREFERRED EMBODIMENT

Hereinafter, an embodiment of the present invention is described in detail with reference to the accompanying drawings.

Face Image Recording Media Generation Apparatus

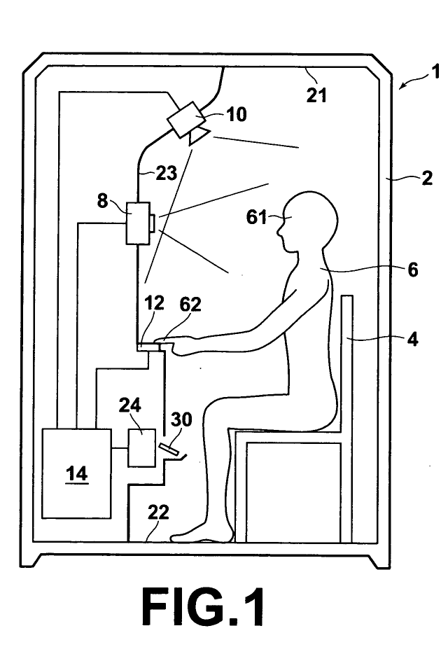

First is described generation of a face image recording medium used for the service provision method of the present invention. FIG. 1 shows a side view of the inside of a digital self-photography booth as an example of an apparatus generating the face image recording medium. A digital self-photography booth 1 has a chair 4 on which a person 6 sits down for photography of his/her face 61, in a housing 2 having a size in which only one person is accommodated. In front of the chair 4 is a partition wall 23 extending from a ceiling 21 to a floor 22. A digital camera 8 is fixed on the partition wall 23 for face photography at a position facing the face 61 of the person 6 sitting on the chair 4. Above the digital camera 8 is fixed a monitor camera 10 having a wide-angle lens whose angle of view includes the face 61 and hands 62 of the person 6.

The digital camera 8 photographs the face 61 of the person 6 sitting on the chair 4, and outputs a face image data set. The monitor camera 10 photographs and monitors the face 61 and the hands 62 of the person 6, for checking occurrence of an abnormal state such as the case where the face 61 of the sitting person 6 is photographed while a finger of another person entering the housing 2 is put on a fingerprint sensor 12. The monitor camera 10 confirms that no abnormal state has occurred and outputs a signal proving that the face image data set belongs to the person represented by a fingerprint obtained by the fingerprint sensor 12. An abnormal state can be recognized by using various kinds of image recognition software. For example, a detector can be used that outputs a signal that indicates an abnormal state by recognition of a state different from a normal state having been learned.

Either the digital camera 8 or the monitor camera 10 outputs authenticity information representing that a face image obtained by the digital camera 8 represents a genuine image without manipulation thereon. This information indicates the fact that the photography has been carried out by the digital camera 8 that cannot carry out manipulation at the time of photography, and the fact is proven by recording the authenticity information in the recording medium at the same time of recording of the face image data set therein. More specifically, the authenticity information may be recorded together with the image data set, as a model number specific to the digital camera 8 used for the photography. Alternatively, the authenticity information is recorded as an electronic watermark embedded in the image data set.

The fingerprint sensor 12 for obtaining the fingerprint is installed at a position reachable by the hands 62 of the person 6, on the partition wall 23 of the housing 2.

The digital camera 8 photographing the face 61, the monitor camera 10, and the fingerprint sensor 12 are connected electronically to a control apparatus 14 installed on the backside of the partition wall 23, and the control apparatus 14 carries out processing described below in response to signals output from the respective cameras and the sensor.

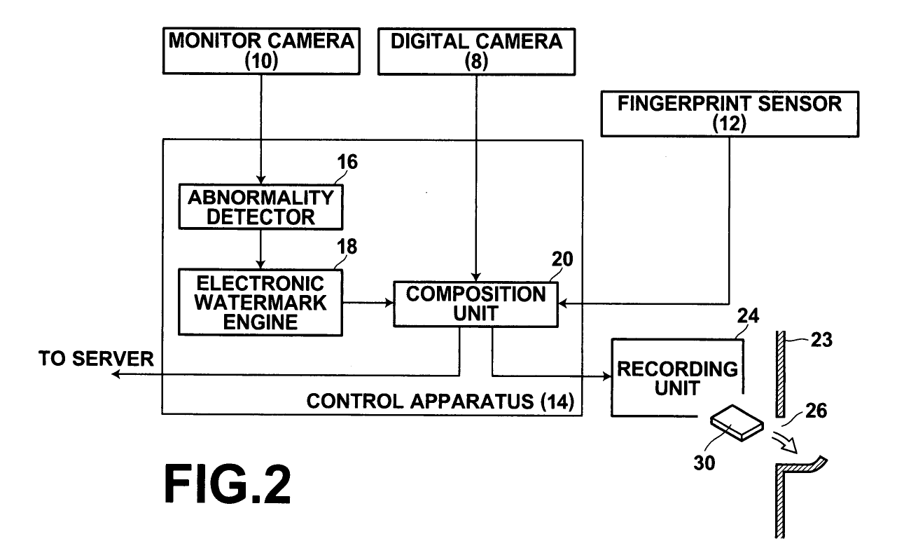

As shown in FIG. 2, the control apparatus 14 generates the face image recording medium by processing the signals received from the digital camera 8 that photographs the face 61 for outputting the face image data set, from the monitor camera 10, and from the fingerprint sensor 12. The control apparatus 14 in this embodiment comprises an operating state detector 16 for outputting the authenticity information representing that no abnormal state has occurred by processing the signal from the monitor camera 10, an electronic watermark engine 18 for embedding an electronic watermark in the face image data set in response to output of the authenticity information, a compositing unit 20 for compositing the signal from the digital camera 8 with the signal from the fingerprint sensor 12 and for embedding the electronic watermark in the composited signal, and a recording unit 24 for recording the composited data in a recording medium so as to generate the face image recording medium 30.

The digital camera 8 outputting the face image data set by photography of the face 61 has a timer built therein, and records time and date of the photography together with the image data set. The time and the date function as information representing an effective period of the face image recording medium 30 having been generated. For example, this information contributes to operation such as invalidation of the recording medium 30 after 6 months from the date.

The recording unit 24 is recording means for generating the face image recording medium 30 by recording the data generated through embedment of the electronic watermark at least either in the face image data set from the digital camera 8 or in fingerprint image data from the fingerprint sensor 12, in a computer-readable recording medium such as a ROM. The face image recording medium 30 generated in this manner is ejected from a slit 26 in the partition wall 23.

The face image recording medium 30 may be an IC chip or an IC chip embedded in a support of an appropriate size for easy handling thereof. Alternatively, the face image recording medium 30 may be a memory of an appropriate size. In order not to mix up a plurality of recording media, the image of the face represented by the face image data set recorded therein may be printed on the surface thereof as a visible image so that the person or a person dealing with the recording medium 30 can immediately confirm the recording medium 30.

The face image recording medium 30 generated in the above manner cannot be falsified once the medium has been generated. Therefore, the face image recording medium 30 can be used for various kinds of applications as a recording medium storing the genuine face image data set without manipulation thereon, like a conventional identification photograph. Furthermore, by downloading the face image data in the recording medium to a personal computer, an electronic application can also be filed by attachment of the data to an e-mail.

Since the face image recording medium 30 does not have any personal information but only stores the face image data set, the recording medium 30 can be used for reception of a service by recognition of face without notification of personal information. For example, if a service provider such as a restaurant or a sports stadium has an apparatus for recognizing face (since many face recognition techniques have been proposed and realized), the face image data set may be sent to the service provider in advance so that the service provider can recognize the face and permit entrance without inquiring the name or confirmation by using a reservation list when the person visits the service provider.

Service Provision System

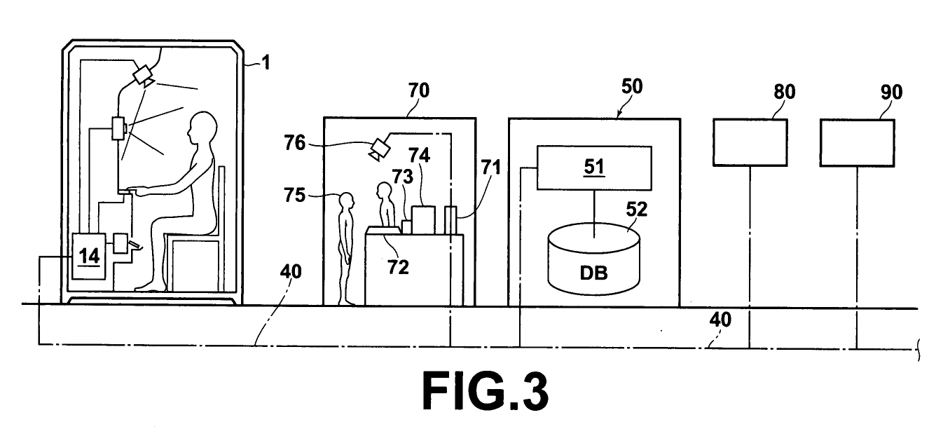

A system used for actually providing the service described above is described next with reference to FIG. 3. As shown in FIG. 3, a ticket reservation computer system is installed in a ticket agency 70 as an example of the service provider. The ticket reservation computer system comprises a general processor 71, an input device 72 such as a keyboard, a card reader 73, and display means 74 such as a liquid crystal display device. The processor 71 is connected to a management station 50 in an interactive manner via an optical fiber communication network 40, for example. Inside the ticket agency 70 is installed a TV camera 76 for photographing the face of a visitor 75. A video signal output from the TV camera 76 is subjected to appropriate processing such as format conversion and input as a photography data set to the processor 71.

Ordinarily, other agencies such as agencies 80 and 90 respectively having the same system as the agency 70 are also operating, and the processor installed in the same manner as the processor 71 in each of the agencies is connected interactively to the management station 50 via the optical fiber communication network 40.

The management station 50 has a server 51 including a database 52. The server 51 is connected to the control apparatus 14 of the self-photography booth 1 shown in FIG. 1. The server 51 has functions for recording a new face image data set sent thereto in the database 52, for searching the database 52 for a face image data set sent thereto for invalidation that will be described later and for invalidating the face image data set having been found, and for judging validity of a face image data set upon inquiry about the validity thereof and for notifying the judgment results regarding validity.

The visitor 75 to the agency 70 presents the face image recording medium 30 having been obtained in the manner described above, at the time of ticket reservation. The face of the visitor 75 is photographed by the TV camera 76, and the photography data set obtained by the photography is input to the processor 71.

The face image recording medium 30 is set on the card reader 73, and the face image data set recorded therein is read. The processor 71 compares the face image data set with the photography data set, and judges whether the face represented by the face image data set is the same as the face represented by the photography data set from the TV camera 76. This judgment can be made according to a known method using pattern matching or the like. The processor 71 displays conformation information such as “Reservation Enabled” on the display means 74 as a result of authentication in the case where the both data sets have been judged to represent the same face.

A clerk or the like of the agency 70 can confirm that the visitor 75 has a membership with the agency and has a ticket reservation right as a request right, by viewing the display on the display means 74. For this confirmation, a code representing the membership is recorded in the face image recording medium 30 by application for the membership at the time of generation of the recording medium 30 in the digital self-photography booth 1 or by setting the recording medium 30 on the card reader 73 at the agency 70 after generation of the recording medium 30. In this manner, the code is detected at the time of authentication, which is used as a condition for display of the conformation information such as “Reservation Enabled”.

Procedures from ticket reservation to provision of a ticket are described next with reference to FIG. 5. In FIG. 5, the procedures are shown by P1˜P11, while M1 to M4 respectively refer to the visitor 75, an acquaintance of the visitor 75, a person relevant to the acquaintance, and the ticket agency 70 as the service provider.

The visitor M1 is authenticated in the above manner (P1). Thereafter, the visitor M1 books a ticket of an event such as a concert or a sports event (P2). In this example, selling the ticket is the service provided by the ticket agency M4. The ticket agency M4 accepts the booking (P3), and issues a reservation before the ticket is actually issued (P4). The reservation is made by issuing a reservation form describing a combination of ticket recognition data such as “XXXX Concert, Month Y, Day Z, Seat WW” and validation data specific to the reservation.

If the visitor M1 thereafter finds that he/she cannot go to the event due to his/her busy schedule or the like, the visitor M1 transfers the reservation of the ticket as the reservation of the service to the acquaintance M2 (P5), and the acquaintance M2 receives the transferal (P6). The visitor M1 notifies the combination of the ticket recognition data and the validation data to the acquaintance M2.

The acquaintance M2 presents the reservation to the ticket agency M4 during a period of ticket issuance (P7), and notifies his/her intension to purchase the ticket. At this time, the acquaintance M2 notifies the combination of the ticket recognition data and the validation data notified by the visitor M1 to the ticket agency M4.

The ticket agency M4 compares the combination of the ticket recognition data and the validation data with a record stored in the agency, and confirms that the combination notified by the acquaintance M2 agrees with the combination used when the ticket reservation was issued. In this manner, the ticket agency M4 confirms that the visitor M1 has legally transferred the reservation to the acquaintance M2 (P8). After the confirmation, the ticket is sold as provision of the service to the acquaintance M2 (P10) unless a procedure at P9 which will be described later is carried out. In this manner, the acquaintance M2 receives the ticket (P11).

The procedures from P7 to P11 may be carried out when the acquaintance M2 directly visits the agency M4. Alternatively, the acquaintance M2 may use a telephone or the Internet for information notification and receive the ticket by mail, for example. In this manner, the procedures from P7 to P11 may be carried out even if the acquaintance M2 does not visit the agency M4.

The procedure at P9 is described next. The person M3 relevant to the acquaintance M2 is a parent thereof in this example. As in the case where the person other than the visitor M1 is going to receive the service for the visitor M1, the service provider may prioritize an intention of the relevant person having a predetermined relationship with the person other than the visitor if the relevant person notifies the service provider of the intension. In the above example, in the case where the parent M3 of the acquaintance M2 notifies the ticket agency M4 of refusal of the service to be provided, the ticket agency M4 does not sell the ticket to the acquaintance M2. In this manner, the case can be avoided where a service for an adult is provided to a minor, for example.

If how many times the visitor M1 having the right to reserve tickets as the request right can transfer the right to another person such as the acquaintance M2 is limited to a predetermined number of times, the visitor M1 can be prevented from abusing the right to reserve tickets for another person.

Although the embodiment of the present invention applied to the case of ticket reservation and selling has been described above, the service provision method of the present invention is not necessarily limited to this embodiment. The present invention can also be applied to a wide range of fields, such as to the case of reserving and using a golf course of a golf club and to the case of reserving and using an accommodation facility.

As has been described above, the face image recording medium 30 does not have any personal information recorded therein. Therefore, no personal information is leaked even in the case where the recording medium 30 is lost, which is safe in terms of personal information protection. However, invalidation of the face recording medium 30 is desired for preventing illegal use thereof in the case where the recording medium 30 is lost.

Invalidation Apparatus and Reissuing Apparatus for Face Image Recording Media

An apparatus for invalidating the face image recording medium 30 may be the self-photography booth 1 for generating the face image recording medium 30 as shown in FIG. 1, in terms of hardware. However, invalidation is necessary inmost cases in a situation where the recording medium 30 generated in the past is not held. Therefore, the data in the recording medium 30 generated in the past need to have been stored in somewhere else. Furthermore, since invalidation refers to an act causing the recording medium to be unusable by a person who found the recording medium. Therefore, a system is necessary for inquiring whether the recording medium 30 has not been invalidated when the recording medium 30 is presented. Consequently, although the apparatus for invalidation can be the self-photography booth 1, a server having a database that can be referred to is also necessary. Hereinafter, an example of this case is described with reference to FIGS. 2 to 4.

For invalidation, the face image data set as the target of invalidation is confirmed and invalidated, and judgment needs to be made as to whether a face image data set sent for inquiry is the same as the face image data set having been invalidated. For this purpose, the face image data set is preferably added with ID information, and judgment needs to be made as to whether the ID information agrees between the face image data sets. For the face image data set showing the agreement, the fact of invalidation is then notified. As such ID information, the time and the date of photography by the digital camera 8 are the most preferable.

As shown in FIG. 3, the control apparatus 14 of the self-photography booth 1 as the face image recording medium invalidation apparatus is connected interactively with the management station 50 via the optical fiber communication network 40. As shown in FIGS. 2 and 3, the data set output from the compositing unit 20 in the control apparatus 14 of the self-photography booth 1 is sent to the server 51 in the management station 50. The same data set as the data set recorded in the face image recording medium 30 is stored in the database 52. The server 51 has functions for recording a new face image data set sent thereto in the database 52, for searching the database 52 for a face image data set sent for invalidation thereof and for invalidating the face image data set having been found, and for judging validity of a face image data set upon inquiry thereof and for notifying invalidity in the case where the face image data set has been invalidated.

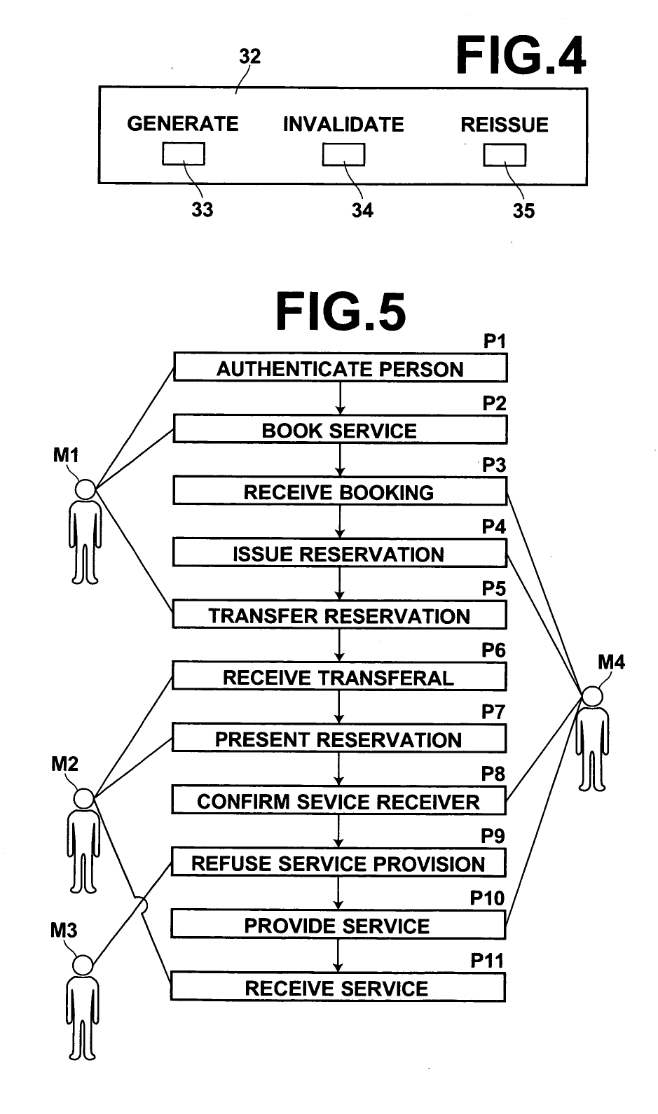

The self-photography booth 1 as the invalidation apparatus has an Invalidate button 34 in the operation panel 32 as shown in FIG. 4. The self-photography booth 1 as a reissuing apparatus has a Reissue button 35 in addition to the Invalidate button 34. However, in reality, it is desired for invalidation and reissuing of the face image recording medium to be carried out in the same self-photography booth used for generation thereof. Therefore, the operation panel 32 of the self-photography booth 1 has the Invalidate button 34 and the Reissue button 35 in addition to a Generate button 33, as shown in FIG. 4.

When the Invalidate button 34 is pressed, the face 61 is photographed in the same manner as in the case of generation, and the face image data set is sent to the server 51. The server 51 searches the database 52 for the face image data set showing the face agreeing with the face represented by the face image data set having been sent thereto. The server 51 then invalidates the face image data set having been found. The face image data set that is invalidated is the face image data set obtained before photography of the face for invalidation.

For the invalidation, notification is necessary of invalidation of the face image data set having been sent to the server 51 for inquiry on validity thereof. Therefore, agreement needs to be detected accurately between the face image data set having been sent thereto and the face image data set stored in the database 52. Therefore, in terms of accuracy and efficiency, it is preferable for the ID information to be added to the face image data set so that invalidity is notified based on agreement of the ID information. Consequently, it is preferable for the face image data set to be added with the ID information specific thereto. The time and the date of photography may be used as the ID information. However, using only the time and the date cannot distinguish the face image data set from a face image data set photographed at the same time on the same date by another one of the self-photography booths 1. For this reason, the most preferable ID information is a combination of the time and the date with information (a serial number) identifying the digital camera or the self-photography booth 1 which carried out the photography. Alternatively, the ID information may be a combination of the time and the date of photography with position data identifying the position of the self-photography booth 1. In this case, the self-photography booth 1 has a GPS function so that the position data based on GPS can be used.

The apparatus reissuing the face image recording medium 30 can be the self-photography booth 1 used as the generation apparatus shown in FIG. 1, in terms of hardware. Reissuing is carried out in the case where the face image recording medium 30 storing the face image data not having expired is lost or stolen and invalidated and generation of a new face image recording medium usable by the holder is desired. The case where the face image recording medium 30 generated in the past has expired and a new face image recording medium is issued is the same as the case of generation and is different from reissuing. If a new face image recording medium is generated according to the procedures of ordinary generation after the face image data set used in the past has been invalidated by operation of the invalidation apparatus, the face image recording medium can be actually reissued. However, the face image generated in the past can also be used at the time of reissuing. In this case, photography is not necessarily carried out anew.

However, in order not to carry out photography again, another means such as biometrics data needs to be used for authenticating the holder. More specifically, the person who desires reissuing obtains his/her fingerprint in the self-photography booth 1 and sends data representing the fingerprint to the management station 50 for comparison with the fingerprint data obtained in the past. The face image data set related to the fingerprint data agreeing with the fingerprint data having been sent is then read, and the ID information (the self-photography booth number and the time and the date of photography) of the face image data set is overwritten by the ID information at the time of reissuing, that is, by the self-photography booth number and the time and the date of photography for reissuing. By sending to the self-photography booth 1 the ID information and the face image data set for recording in a new face image recording medium, the new effective face image recording medium can be reissued.

What is claimed is:

1. A service provision method comprising:
authenticating a person by a face image recording medium readable by a computer and storing face image data of the person, authenticity information indicating that the face image data represent a genuine image of the person, and information representing an effective period in a state enabling no falsification thereof;
granting a predetermined request right to the person having been authenticated; and
providing a predetermined service in response to presentation of the predetermined request right, the method further comprising the steps of:
issuing a reservation of the service with a combination of recognition data of the service and validation data specific thereto in the case where the person having been authenticated requests the reservation of the service based on the request right;
receiving a request for provision of the service having been reserved, by causing a combination of recognition data of the service and validation data specific thereto to be presented; and
providing the requested service in the case where the presented combination agrees with the combination used at the time of issuing the reservation.

2. The service provision method according to claim 1, wherein the service is provided only within a predetermined number of times in the case where a person requesting provision of the service is different from the person having been authenticated.

3. The service provision method according to claim 1, wherein the service is provided only for preset types of reservations in the case where a person requesting provision of the service is different from the person having been authenticated.

4. The service provision method according to claim 2, wherein the service is provided only for preset types of reservations in the case where a person requesting provision of the service is different from the person having been authenticated.
